(19) United States
(12) Patent Application Publication
(10) Pub. No.: US 2019/0227447 A1
(43) Pub. Date: Jul. 25, 2019

(54) Magnetic Spherical Toner

(71) Applicant: Static Control Components, Inc., Sanford, NC (US)

(72) Inventor: Bryan Patrick Livengood, Nicholasville, KY (US)

(21) Appl. No.: 16/190,340

(22) Filed: Nov. 14, 2018

Related U.S. Application Data
(60) Provisional application No. 62/619,413, filed on Jan. 19, 2018.

(51) Int. Cl. G03G 9/08; G03G 9/087; G03G 9/083

(52) U.S. Cl. CPC G03G 9/0804; G03G 9/0819; G03G 9/0839; G03G 9/08782; G03G 9/08755

(57) ABSTRACT

A magnetic chemical toner comprising toner particles with high circularity (i.e., above 0.970) is described. The high circularity of the toner particles can maximize transfer efficiency and prevent toner waste during printing. The toner particles can comprise a polyester resin-based core. If desired, the toner particles can comprise a surface coating to modulate toner properties. Also described is a method of preparing the magnetic toner and a method of using the toner to print an image.

The present application claims the benefit of U.S. Provisional Application No. 62/619,413 filed Jan. 19, 2018 and entitled “MAGNETIC SPHERICAL TONER”.

### TECHNICAL FIELD

The presently disclosed subject matter relates to a magnetic toner for use in electrophotography, as well as to method of preparing and using the toner. The presently disclosed toner can comprise magnetic toner particles having high circularity and comprising one or more polyester resins.

### ABBREVIATIONS

° C.=degrees Celsius
%=percentage
μL=microliter
μm=microns
CCA=charge control agent
CPT=chemically prepared toner
D50=median particle diameter
DSC=differential scanning calorimetry
emu=electromagnetic unit
g=grams
Fe₂O₄=magnetite
He=coercive force
m²=square meters
min=minute
mL=milliliter
mm=millimeter
Oe=oersted
Q/M=charge to mass
T_{g}=glass transition temperature
TiO₂=titanium dioxide

### BACKGROUND

Electrophotography is a widely used printing technique that includes the generation of an image on an image-receiving medium (or “substrate”) using a finely divided, electrostatically attractable powder, known as a toner, wherein transfer of the toner to the image-receiving medium is performed with the help of electrostatic charges. The technique of electrophotography is used in photocopying machines, laser printers, light-emitting diode (LED) printers, and the like. Suitable substrates for use in electrophotography include, but are not limited to, paper, plastic, and textiles.

More particularly, in electrophotographic printing processes, a charge retentive surface, known as a photoreceptor, is electrostatically charged, and then exposed to a light pattern of an original image to selectively discharge the surface in accordance therewith. The resulting pattern of charged and discharged areas on the photoreceptor form an electrostatic charge pattern, known as a “latent image”, conforming to the original image. The latent image is developed by contacting it with toner. Toner is held on the image areas by the electrostatic charge on the photoreceptor surface. Thus, a toner image is produced in conformity with a light image of the original being reproduced or printed. The toner image can then be transferred to a substrate (e.g., paper) directly or through the use of an intermediate transfer member, and the image affixed thereto, e.g., via fusing using heat and/or pressure, to form a permanent record of the image to be reproduced or printed. In some cases, subsequent to development, excess toner left on the charge retentive surface is cleaned from the surface. The process is useful for light lens copying from an original or for printing electronically generated or stored originals such as with a raster output scanner (ROS), where a charged surface can be image-wise discharged in a variety of ways.

There is an increasing interest in minimizing the size of printers and copiers in recent years, e.g., due to increased demand for local desktop printing, while still maintaining or increasing print quality. Accordingly, there is a need for additional magnetic toner compositions that can provide improved print quality and/or that are more compatible with the use of smaller toner cartridges and/or printing apparatus.

### SUMMARY

In some embodiments, the presently disclosed subject matter provides a magnetic toner comprising a plurality of magnetic toner particles, wherein each magnetic toner particle comprises one or more polyester binder resin and a magnetic material, and where the plurality of magnetic toner particles have a mean circularity of about 0.970 or greater. In some embodiments, the magnetic toner particles have a median diameter by volume and/or by weight of between about 5.0 microns (μm) and about 10.0 μm. In some embodiments, the magnetic toner particles have a mean aspect ratio of about 0.850 or greater.

In some embodiments, the plurality of magnetic toner particles have a total weight percentage of polyester binder resin of between about 40% and about 85%. In some embodiments, the total weight percentage of polyester binder resin is between about 45% and about 80%. In some embodiments, the total weight percentage of polyester binder resin is between about 60% and about 75%.

In some embodiments, at least one of the one or more polyester binder resins has a glass transition temperature (T_{g}) of between about 50 degrees Celsius (° C.) and about 70° C. In some embodiments, at least one of the one or more polyester binder resins has a T_{g} of between 54° C. and about 65° C.

In some embodiments, the magnetic material comprises magnetite (Fe₃O₄) particles. In some embodiments, the magnetic toner particles have a total weight percentage of magnetite particles of between about 10% and about 50%. In some embodiments, the total weight percentage of magnetite particles is between about 20% and about 40%. In some embodiments, the magnetic material further comprises FeO and/or Fe₂O₃. In some embodiments, the magnetite particles have a coercivity of between about 45 oersted (Oe) and about 80 Oe.

In some embodiments, the magnetic toner particles further comprise a wax, a charge control agent (CCA) and/or a solid plasticizer. In some embodiments, the magnetic toner particles comprise up to about 10% by weight of a solid plasticizer, optionally wherein the solid plasticizer comprises pentaerythritol tetrabenzoate. In some embodiments, the magnetic toner particles comprise between about 1% and about 10% by weight of an ester and/or polyolefin wax, wherein said wax has a melting point of between about 65° C. and about 95° C.

In some embodiments, one or more of the magnetic toner particles have a surface coating of inorganic oxide particles. In some embodiments, the magnetic toner particles comprise a total weight percentage of inorganic oxide particles of between about 0.5% and about 5%. In some embodiments, the inorganic oxide particles comprise titanium dioxide particles and/or fumed hydrophobic silica particles. In some embodiments, the total weight percentage of inorganic oxide particles is between about 2.0% and about 3.5%.

In some embodiments, the inorganic oxide particles have a weight % ratio of fumed hydrophobic silica to titanium dioxide of between about 30% and about 85% fumed hydrophobic silica. In some embodiments, the weight % ratio of fumed hydrophobic silica to titanium dioxide is between about 50% to about 75% fumed hydrophobic silica. In some embodiments, the fumed hydrophobic silica comprises at least two or more different sizes of fumed hydrophobic silica particle. In some embodiments, the toner is a chemically prepared toner.

In some embodiments, the presently disclosed subject matter provides a toner cartridge for an electrophotographic printer, wherein the toner cartridge comprises a magnetic toner comprising a plurality of magnetic toner particles, wherein each magnetic toner particle comprises one or more polyester binder resin and a magnetic material, and wherein the magnetic toner particles have a mean circularity of about 0.970 or greater.

In some embodiments, the presently disclosed subject matter provides a method of preparing a magnetic toner comprising a plurality of magnetic toner particles, wherein each magnetic toner particle comprises one or more polyester binder resin and a magnetic material, and wherein the magnetic toner particles have a mean circularity of about 0.970 or greater, the method comprising: (a) providing toner components, wherein the toner components comprise at least one or more polyester resins and magnetite particles; (b) mixing the toner components to provide toner particles; and (c) isolating the toner particles. In some embodiments, the toner components further comprise one or more of a wax, a charge control agent (CCA), or a solid plasticizer.

In some embodiments, the method further comprises exposing the toner particles to a surface treatment process to provide surface treated toner particles. In some embodiments, the surface treatment process comprises treating the toner particles with one or more inorganic metal oxide particle composition selected from the group comprising (a) a mixture of titanium dioxide and iron oxide particles, (b) fumed silica particles having a specific surface area of 20-90 square meters per gram (m²/g), and (c) fumed silica particles having a specific surface area of 100-300 m²/g, thereby coating a surface of the toner particles with at least one inorganic metal oxide particle composition.

In some embodiments, the presently disclosed subject matter provides a method of printing an image, wherein the method comprises: (i) providing a magnetic toner comprising a plurality of magnetic toner particles having a mean circularity of about 0.970 or greater, wherein each magnetic toner particle comprises one or more polyester binder resin and a magnetic material; (ii) exposing an electrostatically charged charge retentive surface of an electrophotographic printing apparatus to a light pattern conforming to an original image to selectively discharge surface areas on the charge retentive surface and create an electrostatic charge pattern on said surface; (iii) contacting the electrostatic charge pattern with the magnetic toner to attract toner particles to areas of the electrostatic charge pattern on the charge retentive surface to create a toner image; (iv) transferring toner particles from the charge retentive surface to a substrate; and (v) fusing said toner particles to the substrate to provide a printed image. In some embodiments, the electrophotographic printing apparatus is free of a waste hopper and/or a wiper blade to remove remaining toner particles from the charge retentive surface following transfer of the toner particles to the substrate.

In some embodiments, the toner particles have a median diameter by volume and/or by weight of between about 5.0 microns (μm) and about 10 μm. In some embodiments, the toner particles have a mean circularity of about 0.975 or more and/or a median diameter of between about 6.0 μm and about 9.0 μm. In some embodiments, the toner particles further comprise a surface coating comprising titanium dioxide particles and/or fumed hydrophobic silica particles.

Accordingly, it is an object of the presently disclosed subject matter to provide a magnetic toner, toner cartridges comprising the magnetic toner, and methods of making and using the magnetic toner.

An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

FIG. 1 is a flow chart showing a method for preparing a magnetic toner according to an embodiment of the presently disclosed subject matter.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless otherwise indicated, all numbers expressing quantities of size, temperature, time, weight, volume, concentration, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes, but is not limited to, 1, 1.5, 2, 2.75, 3, 3.90, 4, and 5).

As used herein, the terms “chemical toner” and “chemically prepared toner” can be used interchangeably and can refer to toners that are prepared via processes other than conventional mechanical milling or jet-milling.

The term “median diameter” refers to a diameter that is at the midpoint of a distribution of particle diameters in a particle population, such any particle within the particle population has an equal chance of having a diameter above the median diameter or below the median diameter.

### II. Magnetic Toner

According to some embodiments of the presently disclosed subject matter, a magnetic toner with high circularity (for example, a circularity of 0.970 or greater) is provided. In particular, the presently disclosed magnetic toner particles can have increased circularity compared to previously known magnetic toner particles. Generally, for example, magnetic toner particles known in the field are milled toner particles that are produced via a mechanical milling/grinding processes or jet milling processes. Such mechanical toners typically have an average circularity of between about 0.930 and about 0.955.

The circularity of a particle (e.g., a toner particle) can be measured for example, via a flow-type particle image analyzer (e.g., a Sysmex FPIA-3000 flow particle image analyzer, Malvern Instruments, Malvern, United Kingdom). Briefly, a perfect sphere has a circularity of 1.000. The circularity value decreases as the degree of irregularity of the periphery of the particle image increases. In view of the high circularity of the particles of the presently disclosed magnetic toner, it can have increased transfer efficiency and prevent toner waste. Thus, for example, the presently disclosed magnetic toner is particularly suitable for use in printing apparatus that do not contain wiper blades or waste hoppers (e.g., the M102V, M203dw, and M106W laser jet printers from Hewlett-Packard (Palo Alto, Calif., United States of America, and the like). The presently disclosed toner also has improved durability and is capable of providing good quality printed images (e.g., images without ghosting, fogging or the like) even after the printing of a large number (e.g., more than 1,000, more than 2,000, more than 5,000) of sheets.

More particularly, the presently disclosed subject matter provides, in some embodiments, a magnetic toner comprising a plurality of magnetic toner particles, wherein each magnetic toner particle comprises one or more binder resin and a magnetic material, and wherein the plurality of magnetic toner particles have a mean circularity of 0.970 or greater. In some embodiments, the particles can have a mean circularity of about 0.975 or greater. In some embodiments, the particles can have a mean circularity of between about 0.975 and about 0.990 (e.g., about 0.975, about 0.980, about 0.985, or about 0.990).

In addition to high circularity, the particles of the presently disclosed toner also have a mean aspect ratio (i.e., the ratio of the average minor axis/average major axis) close to 1.0. In some embodiments, the magnetic toner particles have a mean aspect ratio of about 0.850 or greater. The aspect ratio of the toner particles can be determined by measuring the major (long) axis and minor (thickness or width) axis of toner particles by analyzing images of particles using transmission electron microscopy (TEM) or scanning electron microscopy (SEM).

The size of the toner particles can be adjusted to provide good flowability and cartridge yield. If the particle size is too small, the toner can have poor flowability. However, if the particle size is larger, too much toner will be required in order to achieve acceptable image density, thus resulting in poor cartridge yield. In some embodiments, the magnetic toner particles can have a median diameter (D50), by volume and/or by weight, of between about 5.0 or 5.5 microns (μm) and about 10.0 μm. In some embodiments, the particles have a D50 of between about 6.0 μm and about 8.5 μm. In some embodiments, the particles have a D50 of between about 6.5 μm and about 8.0 μm (e.g., about 6.5, 6.6, 6.7, 6.8, 6.9, 7.0, 7.1, 7.2, 7.3, 7.4, 7.5, 7.6, 7.7, 7.8, 7.9, or about 8.0 μm).

Any suitable thermoplastic binder resin or combination of resins can be used in the instantly disclosed magnetic toner. For example, suitable binder resins can include styrene-based resins (e.g., polystyrene and copolymers thereof), acrylic acid-based resins, olefin-based resins (e.g., polyethylene, polypropylene, and the like), vinyl-based resins (e.g., vinyl chloride, vinyl alcohol, vinyl ether, and N-vinyl resins), polyamide resins, polyurethane resins, and polyester resins.

In some embodiments, the presently disclosed toner particles comprise one or more polyester resins. The use of polyester resins in the presently disclosed toner can improve fusability, e.g., compared to the use of a styrene copolymer. Polyester resins have also been found to have good compatibility with iron oxides, which can be used as the magnetic material for the toner particles. The polyester binder resin or resins can include one or more semi-crystalline, crystalline, and/or amorphous polyester resin. The polyester binder resin or resins can include both crosslinked and non-crosslinked polymers. The polyester binder resin or resins can include one or more polyester copolymer binder resins, such as, but not limited to, a styrene/acrylic-polyester graft copolymer. In some embodiments, the polyester binder resin or resins comprise semi-crystalline and/or crystalline polyester binder resins. The use of a semi-crystalline or crystalline polyester binder resin can increase the polarity of the toner particles.

Suitable polyester binder resins include products obtained by polycondensation or condensation copolymerization of alcohol components and carboxylic acid components. For example, the alcohol component or components can be selected from the group including, but not limited to, di-, tri- or higher polyhydric alcohols, such as ethylene glycol, diethylene glycol, triethylene glycol, 1,2-propanediol, 1,3-propanediol, 1,4-butanediol, neopentylglycol, 1,5-pentanediol, 1,6-hexanediol, 1,4-cyclohexanemethanol, polyethylene glycol, polytetramethylene glycol; bisphenols, such as bisphenol A, hydrogenated bisphenol A, polyoxyethylene bisphenol A, polyoxypropylene bisphenol; sorbitol, 1,2,3,6-hexanetetraol, 1,4-sorbitan, pentaerythritol, glycerol, diglycerol, 2-methylpropanetriol, and 1,3,5-trihydroxymethylbenzene. The carboxylic acid component or components can be selected from di-, tri- and higher-polybasic acids, such as from the group including, but not limited to, maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkyl succinic acids (e.c., butenylsuccinic acid, octenylsuccinic acid, dodecenylsuccinic acid, etc.), 1,2,4-benzenetricarboxylic acid (trimellitic acid), 2,5,7-napthalenetricarboxylic acid, 1,2,4-naphthalenetricarboxylic acid, 1,2,4-butanetricarboxylic acid, 1,2,5-hexanetricarboxylic acid, pyromellitic acid, and the like. The anhydrides or lower alkyl esters of the polybasic acids (e.g., the di- or tri-carboxylic acids) can also be used as the carboxylic acid component.

In some embodiments, at least one or more of the one or more polyester binder resins has a glass transition temperature (T_{g}), as measured, for example, via differential scanning calorimetry (DSC) (e.g., using second scan DSC onset values) that is above about 40 degrees Celsius (° C.), above about 50° C., or above about 55° C. In some embodiments, at least one or more of the one or more polyester resins have a T_{g} that is between about 50° C. and about 70° C. or between about 54° C. and about 65° C. In some embodiments, one or more of the one or more polyester resins has a T_{g} of between about 57° C. and about 62° C. Suitable polyester toner binder resins are commercially available, for example, from Kao Corporation (Tokyo, Japan), Mitsubishi Rayon (Tokyo, Japan), SK Chemical (Seoul, South Korea), and Samyang (Seoul, South Korea). In some embodiments, the acid value of the resin is between about 0 and about 30. In some embodiments, the acid value is between about 10 and about 20 (e.g., about 10, 11, 12, 13, 14, 15, 16, 17, 18, 19, or about 20). In some embodiments, the molecular weight and/or the gel content of the resin can be varied to provide desired properties.

In some embodiments, the plurality of magnetic toner particles have a total weight percentage (wt %) of polyester binder resin of between about 45% and about 80%. In some embodiments, the particles have a total wt % of polyester binder resin that is between about 50% and about 75% (e.g., 50, 55, 60, 65, 70, or about 75%). In some embodiments, the particles have a total wt % of polyester binder resin that is between about 65% and about 75% (e.g., about 65, 66, 67, 68, 69, 70, 71, 72, 73, 74, or about 75%).

The magnetic material of the instant magnetic toner particles can include, but is not limited to, iron oxides (e.g., FeO, Fe₂O₃, Fe₃O₄), which are present in materials such as ferrite, maghemite, magnetite, or the like or mixtures thereof; metals such iron, cobalt and nickel; and alloys or mixtures of these metals with metals such as aluminum, copper, magnesium, tin, zinc, beryllium, calcium, manganese, selenium, titanium, tungsten, and vanadium. In some embodiments, the magnetic toner particles comprise magnetite (Fe₃O₄) particles. In some embodiments, the magnetic toner particles comprise magnetite particles and one or more other iron oxides, such as particles comprising Fe₂O₃ and/or FeO.

The concentration of magnetic material in the toner particles can be adjusted to provide both good tinting strength and suitable toner tribocharge (Q/M). Lower concentrations of magnetic material can result in lower tinting strength (lower image density), but higher toner tribocharge. In some embodiments, the magnetic toner particles have a total wt % of magnetite particles of between about 15% and about 45%. In some embodiments, the total wt % of magnetite particles is between about 20% and about 40% (e.g., about 20, 21, 22, 23, 24, 25, 26, 27, 28, 29, 30, 31, 32, 33, 34, 35, 36, 37, 38, 39 or about 40%). In some embodiments, the total wt % of magnetite particles is between about 25% and about 37% or between about 27% and about 35%.

In some embodiments, the magnetite particles have a mean particle size of between about 0.1 μm and about 0.6 μm (e.g., about 0.1, 0.2, 0.3, 0.4, 0.5, or 0.6 μm). In some embodiments, the magnetite particles have a coercivity or coercive force (H_{c}) of between about 45 oersted (Oe) and about 80 Oe. In some embodiments, the magnetite particles have a residual magnetization or remanence (σr) of between about 5 and about 12 emu/g. In some embodiments, the magnetite can have a or of between about 4.5 and about 7.5 emu/g. In some embodiments, the magnetite particles have a or of between about 5.5 and about 6.5 emu/g. In some embodiments, the magnetite particles have a saturization magnetization (σm) of between about 80-100 emu/g, or between about 85 and about 95 emu/g, or between about 90 and 93 emu/g. Suitable magnetite particles include, for example, E-8706, commercially available from, for instance, Lanxess (Cologne, Germany).

The magnetic toner particles can also include other components, such as, but not limited to, a releasing agent, a charge control agent, and/or a plasticizer (e.g., a solid plasticizer). In some embodiments, the toner and/or the toner particles can include one or more other optional components, such as, but not limited to, an organic fine powder, an inorganic fine powder, a pigment/colorant, an ultraviolet (UV) absorber, and an antimicrobial agent, and combinations thereof. The use of a UV absorber, for instance, can prevent gradual fading of a printed image prepared using the toner upon exposure of the image to UV light. Suitable UV absorbers include, but are not limited to, benzophenone, benzotriazole, acetanilide, triazine and derivatives thereof.

In some embodiments, the toner particles comprise a release agent. A release agent is typically used to improve fixability and offset resistance of the toner. In some embodiments, the release agent is a wax. Suitable waxes include, but are not limited to, ester waxes (e.g., long chain fatty acid esters, partially saponified fatty acid esters), olefin waxes (e.g., polyethylene waxes and polypropylene waxes), fluororesin-based waxes, Fischer-Tropsch waxes, paraffin waxes, and montan waxes. Ester waxes can include synthetic or natural waxes (e.g., carnauba wax or rice wax). Synthetic ester waxes can be prepared by reacting an alcohol and a carboxylic acid or an alcohol and a carboylic acid halide in the presence of an acid catalyst. The magnetic toner particles can comprise up to about 15 wt % or up to about 10 wt % of a wax or combination of waxes. In some embodiments, the magnetic toner particles comprise between about 1% and about 10% of an ester and/or a polyolefin wax. In some embodiments, the magnetic toner particles comprise between about 3% and about 7% by weight (e.g., about 3%, 4%, 5%, 6%, or about 7% by weight) of an ester and/or polyolefin wax. In some embodiments, the wax has a melting point of between about 60° C. and about 120° C. In some embodiments, the wax has a melting point of between about 65° C. and about 95° C.

In some embodiments, the magnetic toner particles comprise a solid plasticizer (i.e., a plasticizer that is solid at room temperature). In some embodiments, the plasticizer can act to adjust the T_{g} of the thermoplastic resin and/or improve the fuse grade performance of the toner. In some embodiments, the magnetic toner particles can comprise up to about 10% or up to about 5% by weight of a solid plasticizer (e.g., about 0.5, 1.0, 1.5, 2.0, 2.5, 3.0, 3.5, 4.0, 4.5, or about 5.0 wt %). In some embodiments, the solid plasticizer is a solid polyester monomer. In some embodiments, the solid plasticizer is has a melting point that is between about 50° C. and about 150° C. In some embodiments, the solid plasticizer has a melting point that is between about 65° C. and about 120° C. In some embodiments, the solid plasticizer has a melting point that is between about 70° C. and about 115° C. (e.g., about 70, 75, 80, 85, 90, 95, 100, 105, 110 or about 115° C.). In some embodiments, the solid plasticizer is pentaerythritol tetrabenzoate (PETB). In some embodiments, the magnetic toner particles are free of a plasticizer.

In some embodiments, the magnetic toner particles comprise one or more charge control agents (CCAs). The CCA can be used to help produce and/or stabilize a tribocharge in the toner. The CCA can also help prevent deterioration of the charge properties of the toner. Any suitable CCA known in the art or combination of CCAs can be used. Examples of CCAs that can help provide negatively chargeable toner particles include, but are not limited to, organometallic compounds and chelates; monoazo metal compounds; acetylacetone metal compounds; aromatic oxycarboxylic acid-, aromatic dicarboxylic acid-, oxycarboxylic acid-, and dicarboxylic acid-based metallic compounds; aromatic oxycarboyxlic acids, aromatic mono- and polycarboxylic acids and metallic salts, anhydrides, or esters thereof; phenol derivatives, such as bisphenol; urea derivatives; salicylic acid-based compounds comprising a metal; naphthoic acid-based compounds comprising a metal; boron compounds; calixarene; and polymers having sulfonic acid-based functional groups. Examples of CCAs that can help provide positively chargeable toner particles include, but are not limited to, nigrosine and modified nigrosine compounds, such as a fatty acid metal salt thereof; a guanidine compound; an imidazole compound; a quaternary ammonium salt, such as tributylbenzylammonium-1-hydroxy-4-naphtosulfonate, benzyldecyl-hexylmethylammonium salt, decyltrimethylammonium salt, and tetrabutylammonium tetrafluoroborate, and analogs thereof, such as phosphonium salts and lake pigments (e.g., phosphotungstic acid, tannic acid, lauric acid, gallic acid, a ferricyanide, and a ferrocyanide) an azine (e.g., pyridazine, pyrimidine, pyrazine, etc.); an alkoxylated amine, and an alkylamide. In some embodiments, the magnetic toner particles comprise between about 0.5% and about 5.0% (e.g., about 0.5, 1.0, 1.5, 2.0, 2.5, 3.0, 3.5, 4.0, 4.5, or about 5%) by weight of one or more CCAs. In some embodiments, the magnetic toner particles comprise between about 1 and about 3% by weight of one or more CCAs.

In some embodiments, the toner particles can further include a surface layer or coating comprising one or more inorganic particles (e.g., inorganic oxide particles). The surface coating can be used to adjust the mass on the developer roll of the printing apparatus, the toner tribocharge, and/or powder flowability. The inorganic particles can be selected from, for example, silica, alumina, a titanium oxide (e.g., titanium dioxide (TiO₂), also known as titania), magnesium oxide, zinc oxide, a zinc alkanoate (e.g., zinc stearate, etc.), strontium titanate, barium titanate, and combinations thereof.

In some embodiments, the magnetic toner particles comprise a total wt % of inorganic oxide particles of between about 0.5% and about 5% (e.g., about 0.5, about 1.0, about 1.5, about 2.0, about 2.5, about 3.0, about 3.5, about 4.0, about 4.5, or about 5 wt %). In some embodiments, the total wt % of inorganic oxide particles is between about 1.0% and about 4.0%. In some embodiments, the total wt % of inorganic oxide particles is between about 2.0% and about 3.5% (i.e., about 2.0, 2.1, 2.2, 2.3, 2.4, 2.5, 2.6, 2.7, 2.8, 2.9, 3.0, 3.1, 3.2, 3.3, 3.4, or about 3.5%). In some embodiments, the inorganic oxide particles comprise titanium dioxide particles and/or silica particles.

In some embodiments, the silica particles are hydrophobic fumed silica particles. The hydrophobic silica particles can include silica particles treated with a hydrophobic treatment agent, such as, but not limited to, an organosilicon compound, a silicone oil, a straight or branched, saturated or unsaturated long-chain (C₁₀-C₂₂) fatty acid, etc. Thus, suitable hydrophobic treatment agents include, for example, hexamethyldisilazane, trimethylsilane, trimethylethoxysiliane, isobutyltrimethoxysilane, trimethylchlorosilane, dimethyldichlorosilane, dimethyldimethoxysilane, diphenyldiethoxysilane, hexamethyldisiloxane, dimethyl silicone oil, methylphenylsilicone oil, α-methylstyrene-modified silicone oil, chlorophenylsilicone oil, fluorine-modified silicone oil, capric acid, lauric acid, myristic acid, palmitic acid, stearic acid, arachidic acid, and behnic acid.

In some embodiments, the surface coating comprises fumed silica and titanium dioxide particles wherein the wt % ratio between the fumed silica particles and the titanium dioxide particles is between about 30% and about 85% silica particles. In some embodiments, the wt % ratio is between about 40% and about 80% silica particles. In some embodiments, the wt % ratio is between about 50% and about 75% silica particles (e.g., about 50, 55, 60, 65, 70 or about 75% silica particles).

The titanium dioxide particles can have one or more different shapes. In some embodiments, the titanium dioxide particles are a mixture of different shaped particles, including both spherical and acicular shaped particles. In some embodiments, the wt % ratio between the acicular and spherical titanium dioxide particles is between about 15% and about 50% (e.g., about 15%, 20%, 25%, 30%, 35%, 40%, 45%, or about 50%) acicular titanium dioxide. In some embodiments, the wt % ratio between the acicular and spherical titanium dioxide particles is between about 25% and about 45% acicular titanium dioxide.

In some embodiments, the surface coating comprises two or more different sizes of fumed hydrophobic silica particles. For example, the fumed hydrophobic silica particles can comprise a population of large particles and a population of small particles. The large particles can have a specific surface area of between about 10-90 m²/g. The small particles can have specific surface area of between about 100-300 m²/g. Specific surface area can be measured, for example, by the Brunauer-Emmett-Teller (BET) method based on nitrogen adsorption. The specific surface area can be measured using a commercially available specific surface area/pore distribution analyzer that can measure gas adsorption by volume. In some embodiments, the wt % ratio between the large and small fumed hydrophobic silica particles is between about 15% and about 50% large particles (e.g., about 15%, 20%, 25%, 30%, 35%, 40%, 45%, or about 50% large particles). In some embodiments, the wt % ratio of large to small fumed hydrophobic silica particles is between about 25% and about 40% large particles.

In some embodiments, the surface coating can comprise one or more abrasive additive to help keep the toner from sticking to the various laser printer cartridge surface, such as, but not limited to, the doctor blade, the developer roll, and the organic photoconductor. In some embodiments, the abrasive additive can be selected from the group including, but not limited to, strontium titanate (SrTiO₃), silicon carbide, cerium oxide, iron oxide, and combinations thereof. In some embodiments, the abrasive additive comprises strontium titanate. In some embodiments, the toner particles comprise between about 0.2 and about 1.0 weight (wt) % strontium titanate or total abrasive additive (e.g., about 0.2, 0.3, 0.4, 0.5, 0.6, 0.7, 0.8, 0.9, or about 1.0 wt %). In some embodiments, the toner particles comprise between about 0.3 and about 0.6 wt % strontium titanate or total abrasive additive.

In some embodiments, the magnetic toner is a chemically prepared toner (CPT) as opposed to a toner prepared by a conventional milling and/or pulverization process. Various types of CPT toners have been described, including suspension polymerization toners (SPTs), emulsion aggregation toners (EATs)/latex aggregation tones (LATs), toners made from a dispersion of pre-formed polymer in solvent, and CPTs made from a “chemical milling” method. In some embodiments, the presently disclosed toner is a CPT prepared by a process wherein a polyester resin or resins are pre-dissolved in an organic solvent. Preparation of a toner via a chemical method can be advantageous in that it can provide toner particles of a small size and narrow particle size distribution (e.g., about 3-10 μm) and/or provide more particle shape control, while decreasing the amount of energy needed to downsize particles (e.g., by mechanical milling steps). Thus, a chemically prepared process can be more energy efficient. In some embodiments, the toner particles are porous.

In some embodiments, the presently disclosed magnetic toner is provided as part of a toner cartridge suitable for use in an electrophotographic printer. In some embodiments, the toner cartridge comprising the presently disclosed magnetic toner is a refilled and/or refurbished toner cartridge. Thus, for example, the presently disclosed magnetic toner can be used to refill an original equipment manufacturer (OEM) toner cartridge.

### III. Methods of Preparing the Toner

In conventional methods of preparing electrophotographic toner, a binder polymer and other raw materials, such as pigment, low molecular weight wax and charge control agent, are melt blended on a heated roll or in a twin-screw extruder. The resulting solidified blend is then ground or pulverized to form a powder. The low melt elasticity of some of the binder polymers used can increase the off-set of toner to hot fuser rollers of copying machinery and T_{g} can be difficult to control. Furthermore, grinding of the polymer is energy intensive and can result in a wide particle size distribution, which can lower the yield of useful toner.

The preparation of toner via a chemical preparation method can offer advantages. Several types of chemically processed toners (CPTs) have been prepared, including, but not limited to, suspension polymerization toners (SPTs), emulsion aggregation toners (EATs)/latex aggregation toners (LATs), toners made from a dispersion of pre-formed polymer in solvent, and CPTs made from a “chemical milling” method.

In some embodiments, the presently disclosed subject matter provides a method of preparing a magnetic toner having a mean circularity of about 0.970 or greater. In some embodiments, the method can comprise providing toner components, such as one or more polyester resin and a magnetic material, mixing the components to prepare toner particles, and isolating the toner particles. The method can comprise, for example, a chemical preparation method, such as, but not limited to, an evaporative limited coalescence (ELC) method. In such a method, toner particles are obtained by forming a solution of pre-formed polymer in a solvent that is immiscible with water, dispersing the polymer solution in an aqueous medium containing a solid colloidal stabilizer, and removing the solvent by evaporation. The resultant particles are then isolated, washed and dried. The size and size distribution of the particles can be controlled by the relative quantities of the particular polymer employed, the solvent, the quantity and size of the water insoluble solid particulate suspension stabilizer, typically silica or latex, and the size to which the solvent-polymer droplets are reduced by mechanical shearing using, for example, rotor-stator type colloid mills, high pressure homogenizers, agitation, and the like. Representative ELC processes employed in toner preparation are described, for example, in U.S. Pat. Nos. 4,833,060 and 4,965,131 to Nair et al.; U.S. Pat. No. 6,800,412 to Sugiyama et al.; U.S. Pat. No. 7,655,375 to Yang et al.; U.S. Patent Application Publication No. 2004/0161687 to Kim et al; and U.S. Patent Application Publication No, 2012/0003581 to Yang et al.; the disclosures of which are incorporated herein by reference in their entireties.

In some embodiments, the presently disclosed subject matter provides a method of preparing a magnetic toner that comprises one or more of the following steps: (a) providing toner components, wherein the toner components comprise one or more polymer resins and magnetic material particles; (b) dissolving or dispersing the toner components in an organic solvent or solvents to provide an organic phase mixture (e.g., a solution or suspension) or mixtures; (c) dispersing the organic phase mixture or mixtures in an aqueous solution or suspension comprising a particulate stabilizer to form a dispersion; (d) homogenizing the dispersion; (e) removing the organic solvent; and (f) recovering the resultant toner particles. In some embodiments, the organic solvent can be removed by gradually heating the dispersion to evaporate the organic solvent and the water. Alternatively, the dispersion can be sprayed into a dry atmosphere to evaporate the organic solvent to obtain toner particles that can then be further dried to remove water. In some embodiments, the method further comprises separating the particulate stabilizer from the toner particles. In some embodiments, the method further comprises washing and drying the recovered toner particles.

In some embodiments, the polymer resin is a polyester resin or resins. In some embodiments, the magnetic material particles comprise iron oxide particles. In some embodiments, the toner components further comprise one or more of the group including, but not limited to, a releasing agent (e.g., a wax), a CCA, a plasticizer (e.g., a solid plasticizer), an organic fine powder, an inorganic fine powder, a pigment or colorant, an UV absorber, and an antimicrobial agent. In some embodiments, one or more of a wax, a charge control agent (CCA), and a plasticizer (e.g., a solid plasticizer) are dissolved or dispersed in an organic phase mixture.

Any suitable water-immiscible organic solvent that can dissolve the polymer resin can be used, such as, but not limited to, chloromethane, dichloromethane, ethyl acetate, propyl acetate, vinyl chloride, trichloromethane, carbon tetrachloride, ethylene chloride, trichloroethane, toluene, xylene, cyclohexanone, 2-nitropropane, and the like. In some embodiments, the polymer resin is a polyester resin and the organic solvent is an ester solvent, such as, but not limited to ethyl acetate, n-propyl acetate, isobutyl acetate, isopropyl acetate, and mixtures thereof.

The particulate stabilizer can be selected from latex materials (e.g., highly crosslinked latex), fumed silica, and colloidal silica (silicon dioxide). Suitable latex materials are described, for example, in U.S. Pat. No. 4,965,131, the disclosure of which is incorporated herein by reference in its entirety. Thus, in some embodiments, the particulate stabilizer is selected from latex particles and silica particles. When silica is used as the particulate stabilizer, it can be removed from the toner particles by treatment with HF or another fluoride ion source or by adding an alkaline agent, such as potassium hydroxide, to an aqueous solution comprising the toner particles to raise the pH to at least 10.

The amount of particulate stabilizer used can be between about 1 and about 15 parts by weight based on 100 parts by weight of the total toner component solids. The size and concentration of the particulate stabilizer can control the size of the final toner particles. In general, the smaller the size and/or the higher the concentration of such particulate, the smaller the size of the final toner particles.

In some embodiments, a water soluble promoter that affects the hydrophilic/hydrophobic balance of the particulate stabilizer in the aqueous solution/suspension can be added to the aqueous solution/suspension to help drive the particulate stabilizer to organic solvent droplet/aqueous phase interfaces in the dispersion of representative steps (c) and (d) above. Such promoters include, but are not limited to, sulfonated polystyrenes, alginates, carboxymethylcellulose, tetramethyl ammonium hydroxide or chloride, diethylaminoethyl methacrylate, water soluble complex resinous amine condensation products of ethylene oxide, urea and formaldehyde and polyethyleneimine. Promoters can also include gelatin, casein, albumin, gluten and the like or non-ionic materials such as methoxycellulose. The promoter is generally used in an amount of between about 0.2 and about 0.6 parts per 100 parts by weight of aqueous solution.

In some embodiments, the recovered toner particles can be further treated, e.g., to provide a surface coating. Accordingly, in some embodiments, the presently disclosed method further comprises exposing the toner particles to a surface treatment process to provide surface treated toner particles. In some embodiments, the surface treatment process comprises treating the toner particles with one or more inorganic metal oxide particle composition. The inorganic metal oxide particles can be selected from the group including, but not limited to, for example, silica, alumina, a titanium oxide (e.g., titanium dioxide (TiO₂), also known as titania), magnesium oxide, zinc oxide, a zinc alkanoate (e.g., zinc stearate, etc.), strontium titanate, and/or barium titanate. In some embodiments, the inorganic metal oxide particles compositions are selected from the group comprising mixtures of titanium dioxide and iron oxide particles and mixtures of fumed silica particles. In some embodiments, the fumed silica particles have a specific surface area of between about 20 and about 90 m²/g. In some embodiments, the fumed silica particles have a specific surface area of between about 100 and about 300 m²/g. In some embodiments, the surface treatment process comprises treating the toner particles with at least two silica particle compositions, wherein the at least two silica particle compositions comprises compositions of silica particles having different surface areas and/or sizes.

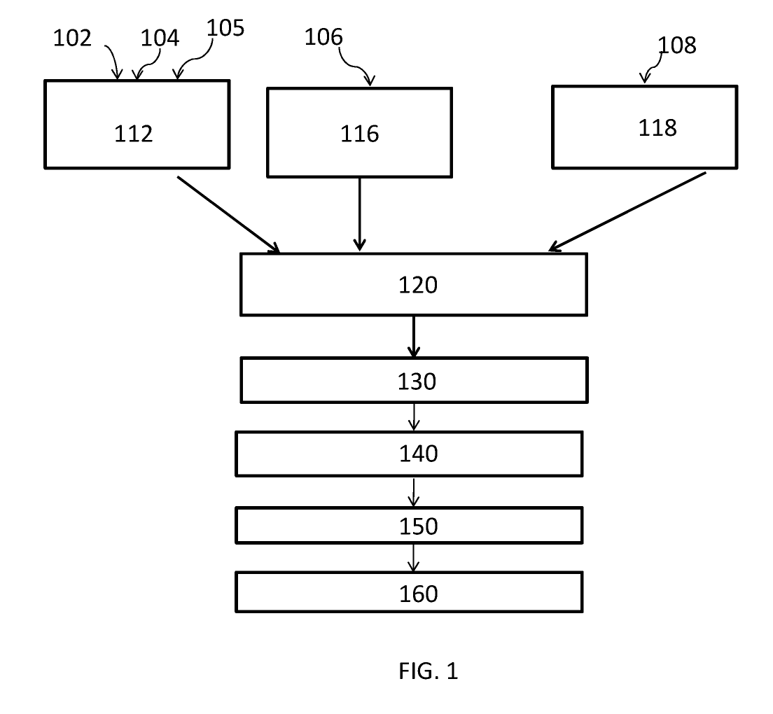

FIG. 1 shows an exemplary method of preparing a toner according to the presently disclosed subject matter. Polymer resin 102 (e.g., a polyester resin) is dissolved in an organic solvent (e.g., ethyl acetate) to provide organic phase solution 112. Additional raw materials, such as wax 104 and charge control agent 105 are dispersed in organic phase solution 112. Magnetic particles (e.g., iron oxide particles) 106 are dispersed in an organic solvent (e.g., ethyl acetate) to provide organic phase dispersion 116. Particulate stabilizer particles 108 are dispersed in water or an aqueous solution to provide aqueous phase suspension 118.

Continuing with FIG. 1, organic phase solution 112, organic phase dispersion 116 and aqueous phase suspension 118 are combined to form dispersion 120, which is homogenized to form homogenized dispersion 130 comprising uniform size organic phase droplets. The organic solvent is then evaporated to form an aqueous mixture 140 comprising solid particles comprising the toner components and stabilizer particles. The organic solvent can be collected and reused (e.g., as a solution/dispersant for resin and/or other toner components for another batch of toner particles). The particulate stabilizer particles can then be destabilized from the surface of the toner particles and separated to provide mixture 150. Mixture 150 can be filtered to separate the toner particles from the aqueous phase. The toner particles can be collected, washed, and dried to provide raw toner particles 160.

At this point, the physical and/or electromagnetic properties of the raw toner particles can be measured. If desired, raw toner particles 160 can be treated to one or more surface treatment process to provide a surface coating on the toner particles. The surface coating can be used to tailor toner properties, e.g., to control toner flowability, the mass on the developer roll during printing, and/or to alter toner Q/M. The surface coating process can include one or more steps and/or one or more coating mixtures. The coating mixtures can include inorganic particles, such as titania and/or silica (e.g., hydrophobic silica). The inorganic particles can comprise more than one size and/or shape of inorganic particles. The surface coating can comprise inorganic particles that comprise between about 0.3 to about 5.0% by weight of the toner particle. In some embodiments, the surface coating can comprise between about 1.0% and about 5.0% by weight of the toner particle (taking into account all surface additives combined). In some embodiments, the surface coating can comprise between about 2.5% and about 4.5% of the weight of the toner particle.

In some embodiments, the surface coating can comprise one or more abrasive additive to help keep the toner from sticking to the various laser printer cartridge surface, such as, but not limited to, the doctor blade, the developer roll, and the organic photoconductor. In some embodiments, the abrasive additive can be selected from the group including, but not limited to, strontium titanate (SrTiO₃), silicon carbide, cerium oxide, iron oxide, and combinations thereof. In some embodiments, the abrasive additive comprises strontium titanate. In some embodiments, the toner particles comprise between about 0.2 and about 1.0 weight (wt) % strontium titanate or total abrasive additive (e.g., about 0.2, 0.3, 0.4, 0.5, 0.6, 0.7, 0.8, 0.9, or about 1.0 wt %). In some embodiments, the toner particles comprise between about 0.3 and about 0.6 wt % strontium titanate or total abrasive additive.

### IV. Method of Printing and Image

In some embodiments, the presently disclosed subject matter provides a method of printing an image using a magnetic, chemically prepared toner and/or a magnetic toner wherein the magnetic toner comprises magnetic toner particles having a mean circularity of about 0.970 or greater (e.g., about 0.970, 0.975, 0.980, 0.985 or greater). In some embodiments, the toner comprises one or more polyester binder resin and/or magnetite.

In some embodiments, the method comprises: (i) providing a magnetic toner comprising a plurality of magnetic toner particles having a mean circularity of about 0.970 or greater, wherein each magnetic toner particle comprises one or more polyester binder resin and a magnetic material; (ii) exposing an electrostatically charged charge retentive surface of an electrophotographic printing apparatus to a light pattern conforming to an original image to selectively discharge surface areas on the charge retentive surface and create an electrostatic charge pattern on said surface; (iii) contacting the electrostatic charge pattern with the magnetic toner to attract toner particles to areas of the electrostatic charge pattern on the charge retentive surface to create a toner image; (iv) transferring toner particles from the charge retentive surface to a substrate; and (v) fusing said toner particles to the substrate (e.g., paper) to provide a printed image. In some embodiments, the electrophotographic printing apparatus is free of a waste hopper and/or a wiper blade to remove remaining toner particles from the charge retentive surface following transfer of the toner particles to the substrate. In some embodiments, the method can be repeated more than 10, 50, 100, 250, 500, 750, 1,000, 2,000, 3,000, 4,000, or 5,000 times or more without providing fresh toner.

In some embodiments, the magnetic toner particles can have a median diameter, by volume and/or by weight, of between about 5.0 microns (μm) and about 10.0 In some embodiments, the particles have a median diameter of between about 5.8 μm and about 8.5 In some embodiments, the particles have a median diameter of between about 6.0 μm and about 8.0 μm (e.g., about 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, or about 8.0 μm). In some embodiments, the toner particles have a mean circularity of about 0.975 or more and/or a median diameter of between about 6.0 μm and about 8.0 μm.

In some embodiments, the toner particles comprise a surface coating comprising inorganic particles (e.g., inorganic oxide particles). In some embodiments, the inorganic particles comprise titanium dioxide particles and/or fumed hydrophobic silica particles or one or more shapes and/or sizes.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

A magnetic CPT was prepared by dissolving dry polyester resin powder (T_{g}=57-62° C.) in ethyl acetate. Wax and a charge control agent were dispersed in ethyl acetate. Iron oxide particles (Bayoxide E 8706, Lanxess, Cologne, Germany) were also dispersed in ethyl acetate. Silica particles were dispersed in water. Then, the ethyl acetate solution and the ethyl acetate and water dispersions were combined together to provide a mixture comprising a predetermined % of each of the raw materials and homogenized using a high shear mixer. The ethyl acetate was evaporated to transform the droplets into solid particles. If desired, the ethyl acetate could be collected, distilled and reused. The silica particles were removed from the solid particles. Then the particles were filtered, washed and dried. The toner particles were then surface treated with 1.00% by weight titanium dioxide (mixture of acicular and spherical particles) as well as 1.50% hydrophobically treated fumed silica (mixture of 50 m\hat{ }2/g and 200 m\hat{ }2/g particles). Surface treatment process was carried out in a 1.5 L blender at 3000 rpm for a total of 5 minutes.

The dried toner particles were analyzed (e.g., with regard to particle size and shape, rheology, and tribocharge). Typical samples of the particles had a particle size of 6-9 μm, with a circularity of 0.980-0.995. The particles comprise about 30% iron oxide, with less than 1% (e.g., about 0.5%) residual silica stabilizer, and less than 0.50% residual ethyl acetate. The particles have a 117-120° C. Shimadzu T1/2, a tribocharge of −20-−30 μC/g and a T_{g} onset (second scan) of 60-65° C.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A magnetic toner comprising a plurality of magnetic toner particles, wherein each magnetic toner particle comprises one or more polyester binder resin and a magnetic material, and wherein the magnetic toner particles have a mean circularity of about 0.970 or greater.

2. The magnetic toner of claim 1, wherein the magnetic toner particles have a median diameter by volume and/or by weight of between about 5.0 microns (μm) and about 10.0 μm.

3. The magnetic toner of claim 1 or claim 2, wherein the magnetic toner particles have a mean aspect ratio of about 0.850 or greater.

4. The magnetic toner of any one of claims 1-3, wherein the plurality of magnetic toner particles have a total weight percentage of polyester binder resin of between about 40% and about 85%.

5. The magnetic toner of claim 4, wherein the total weight percentage of polyester binder resin is between about 45% and about 80%.

6. The magnetic toner of claim 4, wherein the total weight percentage of polyester binder resin is between about 60% and about 75%.

7. The magnetic toner of any one of claims 1-6, wherein at least one of the one or more polyester binder resins has a glass transition temperature (T_{g}) of between about 50 degrees Celsius (° C.) and about 70° C.

8. The magnetic toner of claim 7, wherein at least one of the one or more polyester binder resins has a T_{g} of between 54° C. and about 65° C.

9. The magnetic toner of any one of claims 1-8, wherein the magnetic material comprises magnetite (Fe₃O₄) particles.

10. The magnetic toner of claim 9, wherein the magnetic toner particles have a total weight percentage of magnetite particles of between about 10% and about 50%.

11. The magnetic toner of claim 10, wherein the total weight percentage of magnetite particles is between about 20% and about 40%.

12. The magnetic toner of any one of claims 9-11, wherein the magnetic material further comprises FeO and/or Fe₂O₃.

13. The magnetic toner of any one of claims 9-12, wherein the magnetite particles have a coercivity of between about 45 oersted (Oe) and about 80 Oe.

14. The magnetic toner of any one of claims 1-13, wherein the magnetic toner particles further comprise a wax, a charge control agent (CCA) and/or a solid plasticizer.

15. The magnetic toner of claim 14, wherein the magnetic toner particles comprise up to about 10% by weight of a solid plasticizer, optionally wherein the solid plasticizer comprises pentaerythritol tetrabenzoate.

16. The magnetic toner of claim 14 or claim 15, wherein the magnetic toner particles comprise between about 1% and about 10% by weight of an ester and/or polyolefin wax, wherein said wax has a melting point of between about 65° C. and about 95° C.

17. The magnetic toner of any one of claims 1-16, wherein one or more of the magnetic toner particles have a surface coating of inorganic oxide particles.

18. The magnetic toner of claim 17, wherein the magnetic toner particles comprise a total weight percentage of inorganic oxide particles of between about 0.5% and about 5%.

19. The magnetic toner of claim 17 or claim 18, wherein the inorganic oxide particles comprise titanium dioxide particles and/or fumed hydrophobic silica particles.

20. The magnetic toner of any one of claims 17-19, wherein the total weight percentage of inorganic oxide particles is between about 2.0% and about 3.5%.

21. The magnetic toner of any one of claims 17-20, wherein the inorganic oxide particles have a weight % ratio of fumed hydrophobic silica to titanium dioxide of between about 30% and about 85% fumed hydrophobic silica.

22. The magnetic toner of claim 21, wherein the weight % ratio of fumed hydrophobic silica to titanium dioxide is between about 50% to about 75% fumed hydrophobic silica.

23. The magnetic toner of any one of claim 19, 21, or 22, wherein the fumed hydrophobic silica comprises at least two or more different sizes of fumed hydrophobic silica particle.

24. The magnetic toner of any one of claims 1-23, wherein said toner is a chemically prepared toner.

25. A toner cartridge for an electrophotographic printer, wherein the toner cartridge comprises a magnetic toner of any one of claims 1-24.

26. A method of preparing a magnetic toner of any one of claims 1-24, the method comprising:
(a) providing toner components, wherein the toner components comprise at least one or more polyester resins and magnetite particles;
(b) mixing the toner components to provide toner particles; and
(c) isolating the toner particles.

27. The method of claim 26, wherein the toner components further comprise one or more of a wax, a charge control agent (CCA), and a solid plasticizer.

28. The method of claim 26 or claim 27, wherein the method further comprises exposing the toner particles to a surface treatment process to provide surface treated toner particles.

29. The method of claim 28, wherein the surface treatment process comprises treating the toner particles with one or more inorganic metal oxide particle composition selected from the group consisting of (a) a mixture of titanium dioxide and iron oxide particles, (b) fumed silica particles having a specific surface area of 20-90 square meters per gram (m²/g), and (c) fumed silica particles having a specific surface area of 100-300 m²/g, thereby coating a surface of the toner particles with at least one inorganic metal oxide particle composition.

30. A method of printing an image, wherein the method comprises:
(i) providing a magnetic toner comprising a plurality of magnetic toner particles having a mean circularity of about 0.970 or greater, wherein each magnetic toner particle comprises one or more polyester binder resin and a magnetic material;
(ii) exposing an electrostatically charged charge retentive surface of an electrophotographic printing apparatus to a light pattern conforming to an original image to selectively discharge surface areas on the charge retentive surface and create an electrostatic charge pattern on said surface;
(iii) contacting the electrostatic charge pattern with the magnetic toner to attract toner particles to areas of the electrostatic charge pattern on the charge retentive surface to create a toner image;
(iv) transferring toner particles from the charge retentive surface to a substrate; and
(v) fusing said toner particles to the substrate to provide a printed image.

31. The method of claim 30, wherein the electrophotographic printing apparatus is free of a waste hopper and/or a wiper blade to remove remaining toner particles from the charge retentive surface following transfer of the toner particles to the substrate.

32. The method of claim 30 or claim 31, wherein the toner particles have a median diameter by volume and/or by weight of between about 5.0 microns (μm) and about 10 μm.

33. The method of claim 32, wherein the toner particles have a mean circularity of about 0.975 or more and/or a median diameter of between about 6.0 μm and about 9.0 μm.

34. The method of any one of claims 30-33, wherein the toner particles further comprise a surface coating comprising titanium dioxide particles and/or fumed hydrophobic silica particles.
